(19) United States
(12) Patent Application Publication
(10) Pub. No.: US 2024/0154505 A1
(43) Pub. Date: May 9, 2024

(54) POTENTIAL EQUALISATION ARRANGEMENT FOR AN ELECTRIC MOTOR

(71) Applicant: BRUSS SEALING SYSTEMS GMBH, Hoisdorf (DE)

(72) Inventors: Manfred BRAND, Tremsbüttel (DE); Jürgen GRUNDT, Neumünster (DE); Björn LINDENER, Lübeck (DE); Samuel NEUMANN, Ahrensburg (DE)

(21) Appl. No.: 18/387,215

(22) Filed: Nov. 6, 2023

(30) Foreign Application Priority Data
Nov. 8, 2022 (DE) 10 2022 129 495.1

(51) Int. Cl. H02K 11/40; H02K 7/00

(52) U.S. Cl. CPC H02K 11/40; H02K 7/003

(57) ABSTRACT

Potential equalisation arrangement for an electric motor has a rotating hollow shaft and a grounding device for reducing electrical potential differences between the hollow shaft and a housing. The grounding device has a shaft grounding ring, which has a support body and an electrically conductive grounding element connected thereto, having a flexible grounding lip for contacting a conductive counter face.

### CROSS-REFERENCE TO A RELATED APPLICATION

This application claims priority to German Patent Application No. 10 2022 129 495.1, filed on Nov. 8, 2022, which is incorporated in its entirety herein.

### FIELD OF THE INVENTION

The present invention relates to a potential equalisation arrangement for an electric motor for the reduction of electric potential differences between a rotor shaft and a housing of an electric motor in different fields of application, such as for example in the motor vehicle.

### BACKGROUND OF THE INVENTION

The lack of discharge of electric charges on electric motors or electric drives can significantly reduce the lifetime durability of ball bearings due to undesired spark discharges between the balls and the ball bearing housing. Similarly, the media used for lubrication are exposed to the electrical discharges and can be damaged or destroyed.

Shaft grounding rings are known, for example, from JP S60-167263 U, DE 10 2013 000 982 B4 and DE 10 2014 010 269 B4. By using an electrically conductive non-woven fabric for the material of the grounding element, this is breathable and prevents the development of adverse pressure differences axially on both sides of the shaft grounding ring.

JP 2015-207533 A discloses a shaft grounding ring, which has a brush ring with conductive fibres.

DE 10 2019 133 886 A1 discloses a grounding apparatus for an electric drive, having a support body device and a contact device, wherein the grounding apparatus has at least one opening, which forms an air passage in an axial direction, wherein a support part and a holding part of the support body device are connected to each other in at least one connection area by a reshaping process.

### BRIEF SUMMARY

The invention is based on the object of providing a development of a potential equalisation arrangement for an electric motor.

The invention solves this object with the features of the independent claims. According to the invention, a potential equalisation arrangement for an electric motor is provided with a rotating hollow shaft and a grounding device for the reduction of electrical potential differences between the hollow shaft and a housing, wherein the earthing device has a shaft grounding ring, which has a support body and an electrically conductive grounding element connected thereto, with a flexible grounding lip for contacting a conductive counter face. The invention enables the reduction of electrical potential differences between a hollow shaft and a housing of an electric motor.

The grounding element is preferably arranged inside the hollow shaft, which enables a space-saving arrangement.

The potential equalisation arrangement preferably has a discharge component, wherein the grounding element encloses at least one part of the discharge component. Such a discharge component, preferably extending into the hollow shaft, enables a space-saving discharge of electrical charges from the hollow shaft to the housing.

In a preferred embodiment, the support body is arranged on the outer side of the discharge component and is connected to this. Here, an inner wall of the hollow shaft advantageously forms a cylindrical counter face for the grounding lip. In this embodiment, the shaft grounding ring is arranged with the discharge component in a manner fixed to the housing, and therefore does not rotate, which can be convenient for the full-surface contact between the grounding lip and the counter face.

In another preferred embodiment, the support body is connected non-rotatably with the inner diameter of the hollow shaft and the outer wall of the discharge component forms a cylindrical counter face for the rotating grounding lip. In this embodiment, the shaft grounding ring rotates with the hollow shaft.

Preferably the discharge component consists of an electrically conductive material or has an electrically conductive insert. In an advantageous embodiment, the discharge component is a connecting part that comprises the support body, for example made of a non-conductive material, and the conductive insert.

In particular, the problem exists in embodiments with an outwardly directed grounding lip that the outer diameter of the grounding lip after installation is smaller than in the free, unassembled state. In order to avoid compression or warping of the grounding lip as a result of the installation, the grounding element or the grounding lip advantageously has interruptions on the external periphery. These can be, for example, slots or slot-shaped openings, which can be arranged in the peripheral direction, for example with equal angular intervals. The number and dimensions of the interruptions and the contact segments remaining between the interruptions of the grounding lip can be suitably chosen within wide limits, including a brush-like structure with minimal width of the contact segments. Due to the interruptions, the contact segments and therefore the grounding lip advantageously produce full-surface contact on the counter face.

The grounding element is preferably an annular disc in the unassembled state.

The shaft grounding ring preferably has a guiding and/or clamping ring for the discharge of electrical charge and/or for the fastening of the grounding element to the support body and/or the discharge component. The guiding and/or the clamping ring can preferably have at least one electrically conductive penetrating element, which penetrates the grounding element in the assembled state.

A base material of the grounding element can preferably consist of a fluoropolymer such as PTFE, FKM, an elastomer, or fluorinated thermoplastic. Conductive fillers such as metallic, metallised or metal-coated particulates, fibres and/or hollow spheres, conductive soot, nano tubes or conductive fibres, for example carbon fibres, can be introduced into the grounding element. In some embodiments the grounding element can have an electrically conductive surface coating.

### BRIEF DESCRIPTION OF THE FIGURES

The invention is explained below according to preferred embodiments, with reference to the appended figures.

Shown are:

FIG. 1: a longitudinal section through a potential equalisation arrangement in one embodiment;

FIG. 2: a schematic perspective view of the potential equalisation arrangement according to FIG. 1; and

FIGS. 3, 4: longitudinal sections through potential equalisation arrangements in further embodiments.

### DETAILED DESCRIPTION

The potential equalisation arrangement 10 has a rotating or rotatable hollow shaft 11 and a grounding device 12, which is set up to connect the hollow shaft 11 with a not shown housing of the electric motor in a conductive manner, in order to reduce undesired electrical potential differences between hollow shaft 11 and housing. The potential equalisation arrangement 10 further has an electrically conductive discharge component 21, which is arranged at least partially within the hollow shaft 11 in a manner fixed to the housing, said discharge component serving to produce an electrically conductive connection between the grounding device 12 and the housing of the electric motor. The discharge component 21 is arranged at least partially in the interior of the hollow shaft 11 and can, for example, be arranged coaxially to the axle of the hollow shaft.

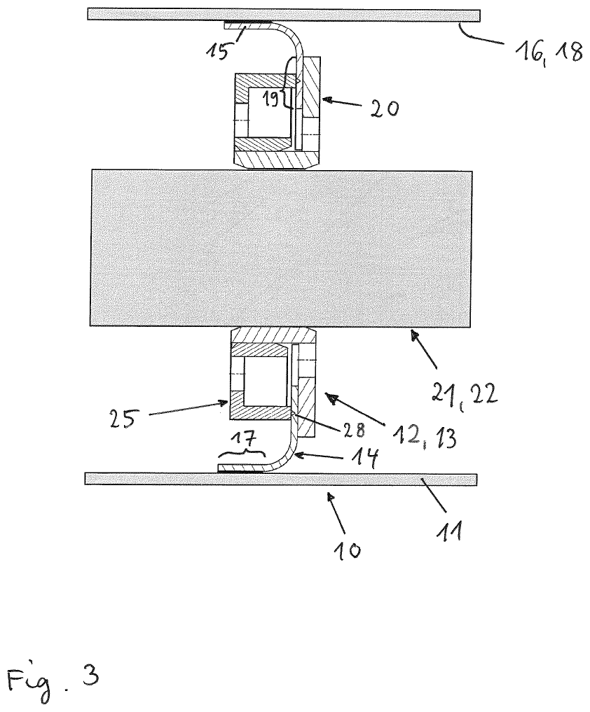

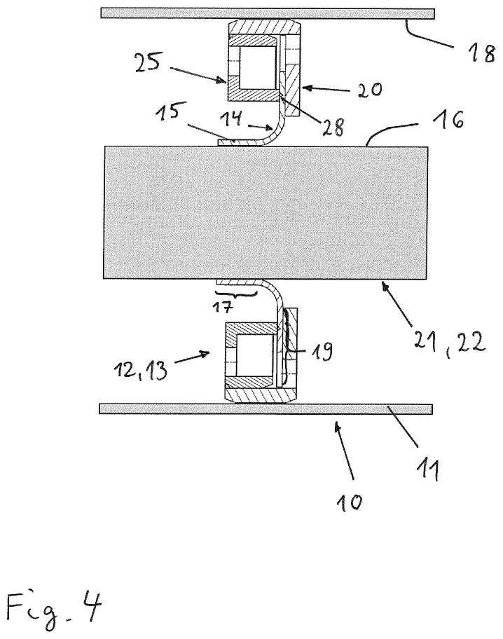

The discharge component 21 in some embodiments has an electrically conductive, in particular metallic, insert 22, which for example can be designed as a tube or a rod. The insert 22 is preferably guided axially outwards, i.e. into an area outside the hollow shaft 11, and connected there in an electrically conductive manner with the not shown housing of the electric motor. In some embodiments, as for example in FIGS. 3 and 4, the discharge component 21 is formed from the insert 22.

The grounding device 12 has a shaft grounding ring 13, which has an electrically conductive, flexible grounding element 14 with a grounding lip 15. The grounding element 14 is connected in a fastening section 19 to a support body 20, for example by means of vulcanisation, which can also be described as a reinforcing support.

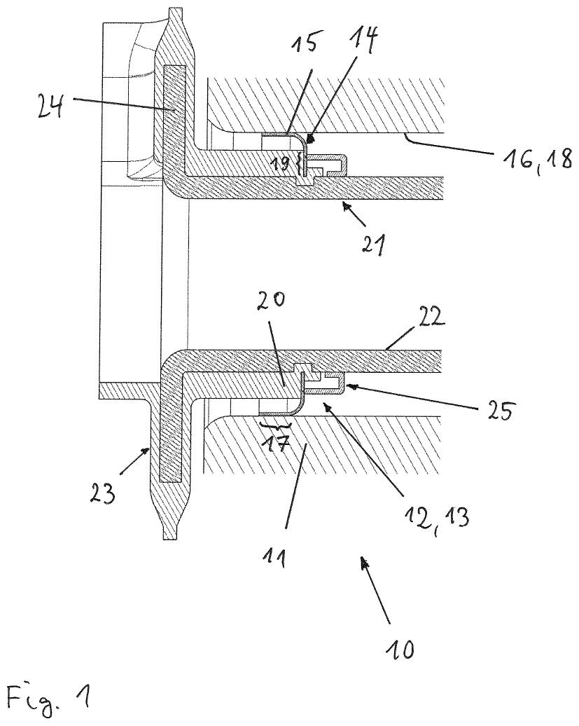

In the embodiment according to FIG. 1, the support body 20 is connected radially outwardly to the insert 22 and forms a composite component 21 with the insert 22. The support body 20 can be electrically non-conductive, for example consisting of a synthetic material and moulded onto the insert 22. The discharge component 21 is guided axially outwards, i.e., into an area outside the hollow shaft 11, and for example angled there at 90°, in order to form a ring-shaped retaining flange 23. The angled part 24 of the insert 22 is connected in an electrically conductive manner to the not shown housing of the electric motor.

The insert 22 is connected in an electrically conductive manner to the not shown housing of the electric motor. The insert 22 can be guided axially outwards, i.e. into an area outside the hollow shaft 11 and for example angled there at 90°, in order to form a ring-shaped retaining flange 24, as in FIG. 1. In the embodiment according to FIG. 3, the support body 20 is attached radially outwardly on the discharge component 21, for example pressed onto this and connected non-rotatably to the discharge component 21. In the embodiment according to FIG. 4, the support body is connected radially inwards with the hollow shaft 11, for example pressed into the inner diameter of the hollow shaft 11, and connected non-rotatably to the hollow shaft 11.

It is possible that the support body 20 and the insert 22 are manufactured from the same material, in particular metal, and form a one-piece, uniform discharge component 21.

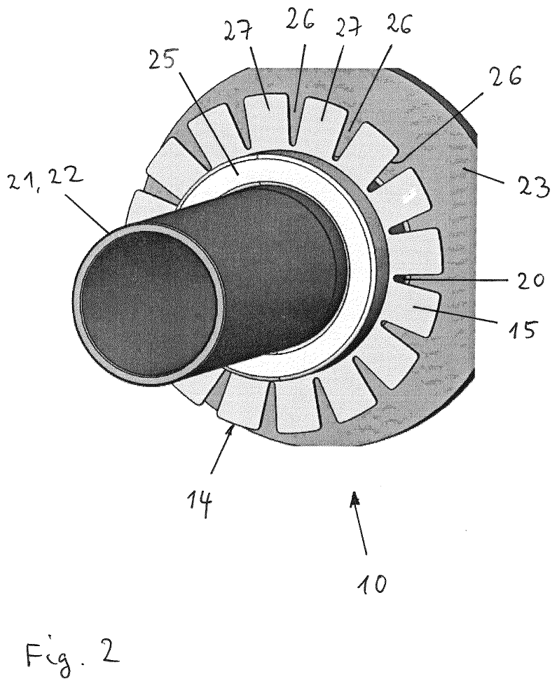

In the unassembled state, such as for example in FIG. 2, the grounding element 14 has the form of a flexible annular disc, which is preferably elastically deformable and/or in one piece.

In the assembled state, such for example in FIGS. 1, 3 and 4, the free end of the grounding lip 15 lies on a cylindrical and electrically conductive, in particular metallic, counter face 16 via an axial contact portion 17, in order to produce an electrically conductive connection between the grounding element 14 and the component forming the counter face 16. The contact portion 17 exerts a radial force on the counter face 16 or the component forming the counter face 16. In this respect, the shaft grounding ring 12 can also be described as a radial shaft grounding ring.

In some embodiments, such as for example in FIGS. 1 and 3, the counter face 16 is formed from the cylindrical inner wall 18 on the inner diameter of the rotating hollow shaft 11. In these cases, the shaft grounding ring 13 and the grounding element 14 are arranged fixed to the housing and non-rotating. The grounding element 14 contacting the hollow shaft 11 is connected by the support body 20 and the electrically conductive discharge component 21 fixed to the housing is connected in an electrically conductive manner to the not shown housing of the electric motor. In this way, electrical potential differences between the rotating hollow shaft 11 and the housing can be reduced.

In other embodiments, such as for example in FIG. 4, the counter face 16 is formed from the cylindrical outer face of the discharge component 21 or the electrically conductive insert 22. In these cases, the shaft grounding ring 13 and the grounding element 14 are arranged to rotate with the hollow shaft 11.

In order to produce the electrical connection between the grounding element 14 and the discharge component 21, in some embodiments, for example according to FIGS. 3 and 4, the support body 20 is electrically conductive, for example metallic. The electrically conductive connection then takes place through the electrical connection of the grounding element 14 and the support body.

In order to improve the electrical connection of the grounding element 14 to the support body 20, a clamping and/or guiding ring 25 can advantageously be provided, with which the grounding element 14 is pressed onto the support body 20. The clamping and/or guiding ring 25 is preferably electrically conductive, in particular metallic. In order to improve the electrical connection between the clamping and/or guiding ring 25 and the grounding element 14, the clamping and/or guiding ring 25 can have penetration elements 28, for example teeth distributed over the periphery of the clamping and/or guiding ring 25, which in the assembled state penetrate the grounding element 14.

If the grounding element 14 is connected non-conductively to the support body 20, for example through the non-conductive adhesive or elastomer, the guiding ring 25 can be required in order to produce contact of the grounding element 14 to the support body 20.

In embodiments in which the support body 20 is electrically non-conductive, as can be the case for example in FIG. 1, the electrical connection between the grounding element 14 and the insert 22 (or in the case of FIG. 4 the hollow shaft 11) is produced by the guiding ring 25, which is connected electrically conductively to the insert 22 (or in the case of FIG. 4 with the hollow shaft 11). If the support body 20 is electrically conductive, for example metallic or an electrically conductive synthetic material, the guiding ring 25 can be omitted, provided the connection of the grounding element 14 to the support body 20 is conductive or non-insulating.

In particular in embodiments with an outwardly directed grounding lip 15, as in FIGS. 1 to 3, the problem exists that the outer diameter of the grounding lip 15 after installation is smaller than in the free, unassembled state. In order to avoid compression or warping of the grounding lip 15 as a result of the installation, the grounding element 14 or the grounding lip 15 advantageously has interruptions 26 on its outer periphery, see FIG. 2. These can be slots or slot-shaped openings, which can be arranged in the peripheral direction, for example with equal angular intervals. The number and dimensions of the interruptions 26 and the contact segments 27 remaining between the interruptions 26 of the grounding lip 14 can be suitably chosen within wide limits, including a brush-like structure with minimal width of the contact segments 27. Due to the interruptions 26, the contact segments 27 therefore produce full-surface contact on the counter face 16.

### REFERENCE NUMERAL LIST

10 potential equalisation arrangement
11 hollow shaft
12 grounding device
13 shaft grounding ring
14 grounding element
15 grounding lip
16 counter face
17 contact portion
18 inner wall
19 fastening section
support body
21 discharge component
22 insert
23 flange
24 angled portion
clamping and/or guiding ring
26 interruptions
27 segments
28 penetrating member

1. A potential equalisation arrangement for an electric motor, having a rotating hollow shaft and a grounding device for reducing electrical potential differences between the hollow shaft and a housing, wherein the grounding device has a shaft grounding ring, which has a support body and an electrically conductive grounding element connected thereto, having a flexible grounding lip for contacting a conductive counter face.

2. The potential equalisation arrangement according to claim 1, wherein the grounding element is arranged in the interior of the hollow shaft.

3. The potential equalisation arrangement according to claim 1, wherein the potential equalisation arrangement has a discharge component, and wherein the grounding element encloses at least one part of the discharge component.

4. The potential equalisation arrangement according to claim 3, wherein the support body is arranged on the outside of the discharge component and is connected to this.

5. The potential equalisation arrangement according to claim 3, wherein an inner wall of the hollow shaft forms a cylindrical counter face for the grounding lip.

6. The potential equalisation arrangement according to claim 3, wherein the support body is connected non-rotatably with the inner diameter of the hollow shaft and the discharge component forms a cylindrical counter face for the rotating grounding lip.

7. The potential equalisation arrangement according to claim 3, wherein the discharge component consists of an electrically conductive material or has an electrically conductive insert.

8. The potential equalisation arrangement according to claim 7, wherein the discharge component is a connecting part that comprises the support body and the electrically conductive insert.

9. The potential equalisation arrangement according to claim 1, wherein the grounding lip has slot-shaped interruptions on its free periphery.

10. The potential equalisation arrangement according to claim 1, wherein the grounding element is an annular disc in the unassembled state.

11. The potential equalisation arrangement according to claim 1, wherein the shaft grounding ring has a guiding and/or clamping ring for the discharge of electrical charge and/or fastening of the grounding element on the support body and/or on the discharge component.

12. The potential equalisation arrangement according to claim 11, wherein the guiding and/or clamping ring has at least one electrically conductive penetrating element, which penetrates the grounding element in the assembled state.

13. The potential equalisation arrangement according to claim 1, wherein a base material of the grounding element consists of a fluoropolymer, an elastomer, or fluorinated thermoplastic.

14. The potential equalisation arrangement according to claim 1, wherein the grounding element conductive fillers are introduced into the grounding element.

15. The potential equalisation arrangement according to claim 1, wherein the grounding element has an electrically conductive surface coating.

16. The potential equalisation arrangement according to claim 14, wherein the grounding element conductive fillers are metallic, metallised or metal-coated particulates, fibres and/or hollow spheres, conductive soot, nano tubes or conductive fibres.
